(19) United States
(12) Patent Application Publication
(10) Pub. No.: US 2015/0295533 A1
(43) Pub. Date: Oct. 15, 2015

(54) BALLASTED FIXED TILT RACKING SYSTEM

(71) Applicant: SUNEDISON LLC, Beltsville, MD (US)

(72) Inventors: Christopher Needham, Sherman, TX (US); Bharat Malapareddy, Bangalore (IN)

(21) Appl. No.: 14/438,810

(22) PCT Filed: Oct. 29, 2013
(86) PCT No.: PCT/US2013/067178

§ 371 Date: Apr. 27, 2015

Related U.S. Application Data
(60) Provisional application No. 61/719,651, filed on Oct. 29, 2012.

(51) Int. Cl. H02S 20/10; B23P 19/00

(52) U.S. Cl. CPC H02S 20/10; B23P 19/00

(57) ABSTRACT

A fixed tilt racking system for mounting solar modules to a structure is disclosed. The fixed tilt racking system has a support rack, a ballast, and a solar module. The support rack includes a pair of trusses, a crossbeam connecting the forward portions of each truss, and a frame assembly connecting the rearward portions of each truss. The ballast is attached to and extends across a back section of the frame assembly. The solar module is connected to both the crossbeam and the frame assembly.

### FIELD

The field relates generally to mounting systems for solar modules and, more specifically, to racking systems for mounting solar modules.

### BACKGROUND

Solar modules for converting solar energy into other forms of useful energy (e.g., electricity or thermal energy) are typically mounted on a support surface by a frame or rack. This rack is also typically mounted to position the solar module at an angle relative to the support surface to minimize an angle of incidence between the solar module and the solar rays. Minimizing the angle of incidence increases the amount of solar energy gathered by the solar module.

Racks are typically formed from a plurality of structural members. These members may be assembled into a rack at a factory or other remote site and then transported to an installation location. The structural members may also be transported to the installation location and then assembled to form the racks on site.

Regardless of whether the rack is assembled at a remote location or at the installation location, a more efficient racking system that reduces the cost of the system and the time and labor required to install the system is needed.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

In one aspect, a fixed tilt racking system for mounting solar modules to a structure includes a support rack. The support rack has a first truss and a second truss, a crossbeam, a frame assembly, a ballast, and a solar module. Each of the first truss and the second truss has a runner, a spacer, a brace, and a support. The runner defines a forward portion, a rearward portion, and a longitudinal length. The spacer extends longitudinally forward from the forward portion of the runner to space the fixed tilt racking systems with respect to another fixed tilt racking system at predetermined distance. The brace is connected with and extends vertically from the runner along the rearward portion. The support is connected with and extends vertically from the runner at a location rearward from the brace. The support is connected with the brace. The crossbeam is connected with and extends horizontally from the forward portion of the runner of the first truss to the forward portion of the runner of the second truss.

The frame assembly is connected with and extends horizontally from the support of the first truss to the support of the second truss. The frame assembly has a mounting bar, a footer, and a plurality of stringers. The mounting bar extends across a top of the frame assembly. The footer extends across a bottom of the frame assembly. Each of the plurality of stringers extends vertically from the mounting bar to the footer. Each of the plurality of stringers is in a spaced relation with another of the plurality of stringers. The ballast is mounted to the frame assembly. The solar module is supported by the crossbeam along a forward edge of the solar module and by the mounting bar along a rearward edge of the solar module. The solar module is substantially unsupported along each side edge.

In another aspect, a fixed tilt racking system for mounting solar modules to a structure includes a support rack. The support rack includes a first and second truss, a crossbeam, a frame assembly, and ballast. Each of the first truss and the second truss has a runner, a brace, and a support. The runner defines a forward portion, a rearward portion, and a longitudinal length. The brace is connected with the runner along the rearward portion of the runner The support is connected with the runner at a location rearward from the brace and is connected with the brace. The crossbeam connects the first truss with the second truss along the forward portion of each runner The frame assembly is connected with and extends horizontally from the support of the first truss to the support of the second truss. The ballast is connected with the frame assembly and each support.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a front perspective of a racking system with solar modules in accordance with one embodiment;

FIG. 2 is a rear perspective of the racking system of FIG. 1;

FIG. 3 is a side view of the racking system of FIG. 1;

FIG. 4 is a front perspective of an array having multiple racking systems of FIG. 1;

FIG. 5 is a front perspective of a solar module in accordance with the embodiment of FIG. 1;

FIG. 6 is a cross-section of the solar module of FIG. 5 taken along line 6-6;

FIG. 7 is a rear perspective of a support rack of the racking system of FIG. 1 but omitting some components;

FIG. 8 is a front perspective of a preassembled truss of the system of FIG. 1;

FIG. 9 is a rear perspective of the preassembled truss of FIG. 8;

FIG. 10 is a side view of a preassembled runner, a brace, and a support in accordance with FIGS. 8 and 9;

FIG. 11 is a perspective view of a crossbar; and

FIG. 12 is a perspective view of a frame assembly.

### DETAILED DESCRIPTION

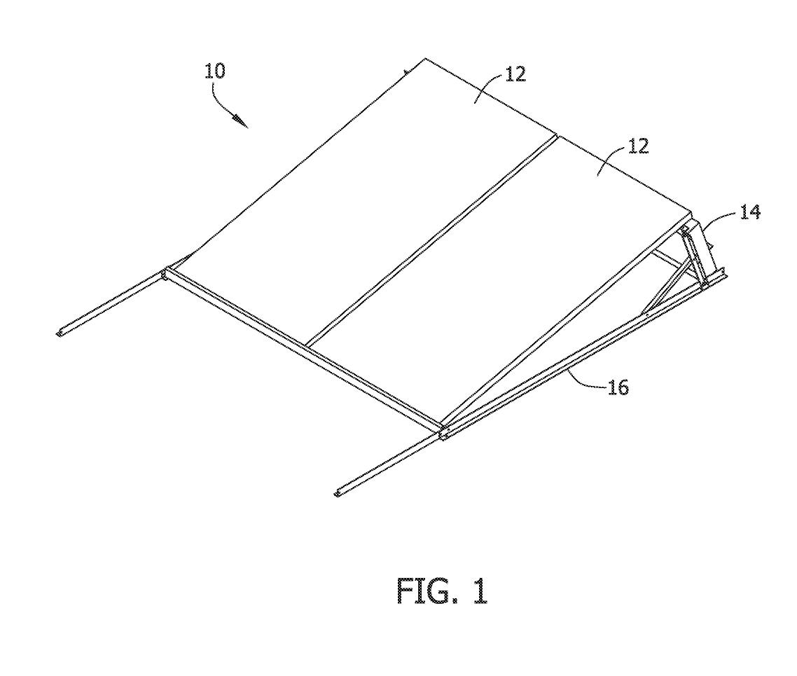

Referring to FIGS. 1-4, a fixed tilt racking system of one embodiment is indicated generally at 10. Fixed tilt racking system 10 generally includes a solar module 12, ballast 14, and support rack 16. The solar module 12 is attached to the top of support rack 16, and the ballast is attached across a back section of support rack 16.

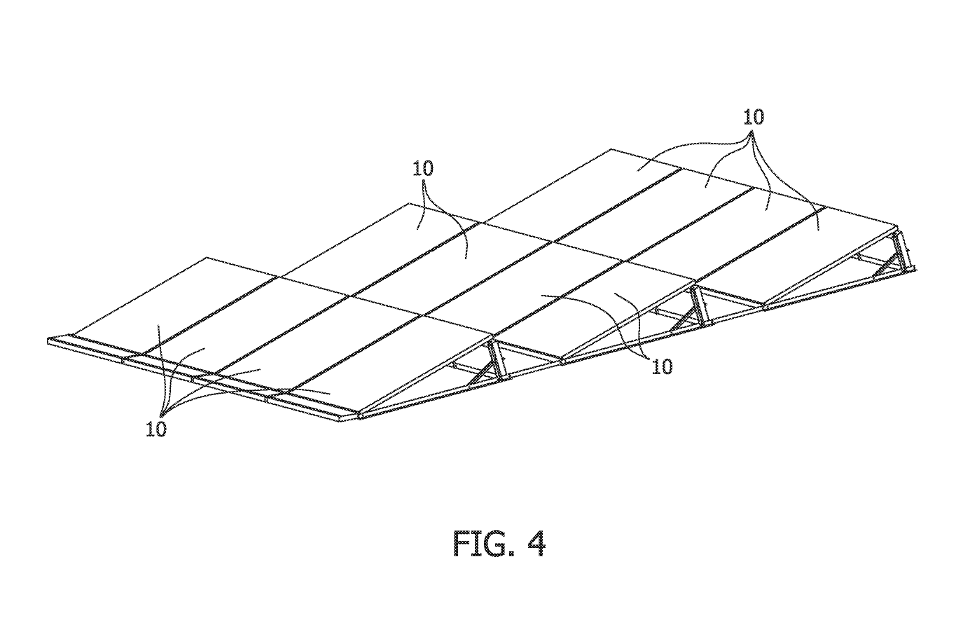

As shown, fixed tilt racking system 10 includes two solar modules 12 adjacent to one another, but in other embodiments, one or more solar modules 12 may be mounted in the racking system 10. Additionally as shown in FIG. 4, a plurality of systems 10 may be mounted in an array. The array may include for example, two, four, six, eight or any number of systems 10.

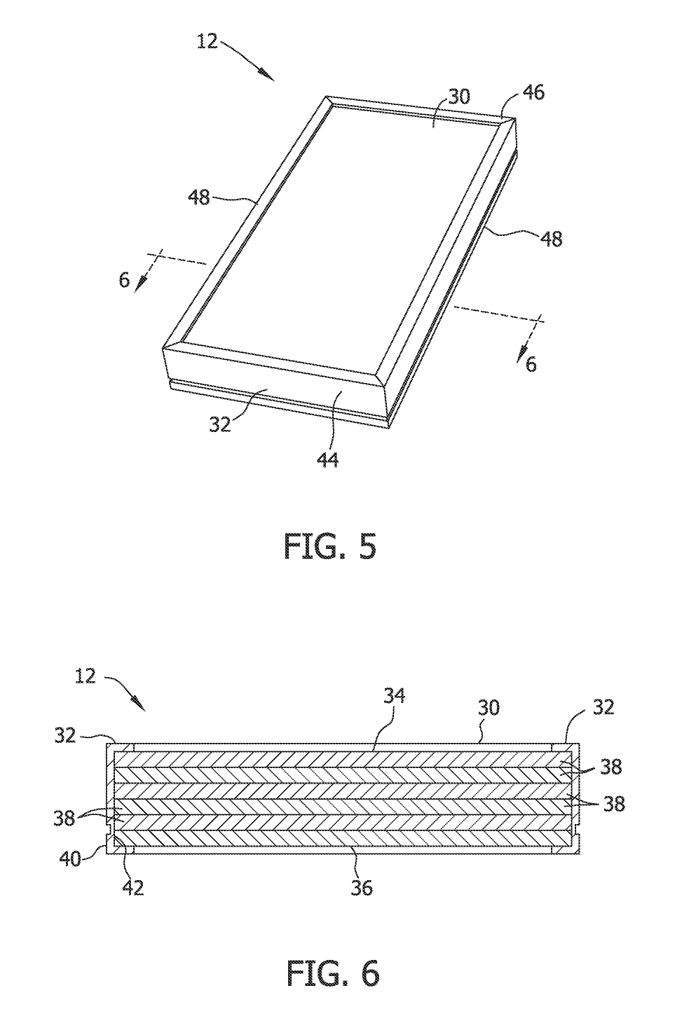

Solar module 12 is shown in more detail in FIGS. 5 and 6. Solar module 12 includes a solar panel 30 and a frame 32 circumscribing solar panel 30. In this embodiment, solar panel 30 is rectangular in shape. However, the solar panel 30 may have other suitable shapes.

As shown in FIG. 6, solar panel 30 includes a top surface 34 and a bottom surface 36. Solar panel 30 suitably has a laminate structure that includes several layers 38. Layers 38 may include for example glass layers, non-reflective layers, electrical connection layers, n-type silicon layers, p-type silicon layers, and/or backing layers. In other embodiments, solar panel 30 may have more or fewer, including one, layers 38, may have different layers 38, and/or may have different types of layers 38.

The frame 32 circumscribes solar panel 30. Frame 32 is coupled to solar panel 30 and assists in protecting the edges of solar panel 30. Exemplary frame 32 includes an outer surface 40 spaced apart from solar panel 30 and an inner surface 42 adjacent to solar panel 30. Outer surface 40 is spaced apart from and substantially parallel to inner surface 42. Outer surface 40 of frame 32 defines a forward edge 44, a rearward edge 46, and side edges 48 of solar module 12.

In the exemplary embodiment, frame 32 is made of aluminum such as for example, 6000 series anodized aluminum. In other embodiments, frame 32 may be made of any other suitable material providing sufficient rigidity including, for example, rolled or stamped stainless steel, plastic, or carbon fiber.

Referring again to FIGS. 1-4, ballast 14 of this embodiment has a rectangular shape and is sized to span the back section of support rack 16 and is attached thereto. As disclosed herein, ballast 14 is suitably a pre-cast concrete block. However, it is envisioned that ballast 14 be constructed of other material. For example, metal plates or sand filled blocks are among the various materials that may be used to form the ballast 14.

Ballast 14 acts as a wind deflector to inhibit or prevent wind from entering under the modules 12 of the system 10. The ballast 14 thereby prevents the system 10 from moving relative to the support structure due to wind entering from the backside of the modules 12. Ballast 14 also provides a downward force (an anchoring force) to the racking system 10.

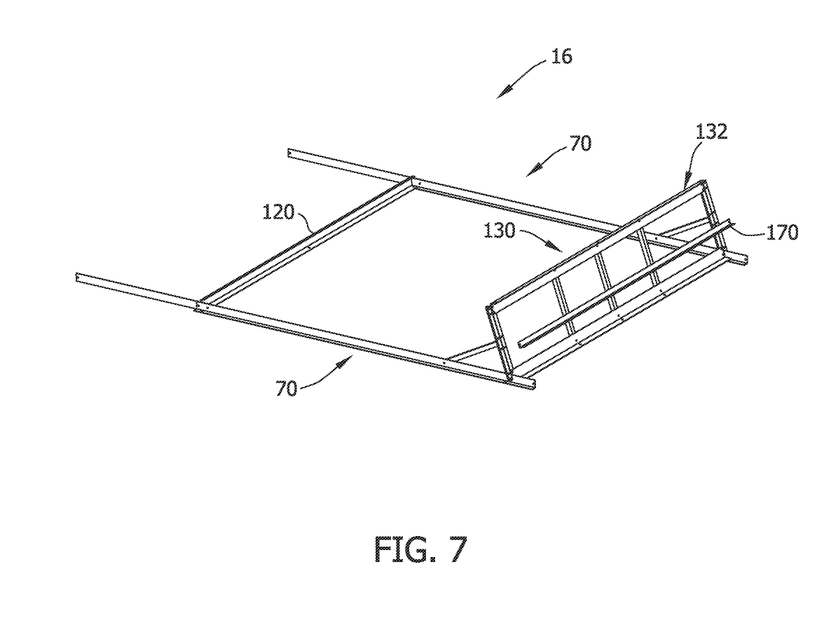

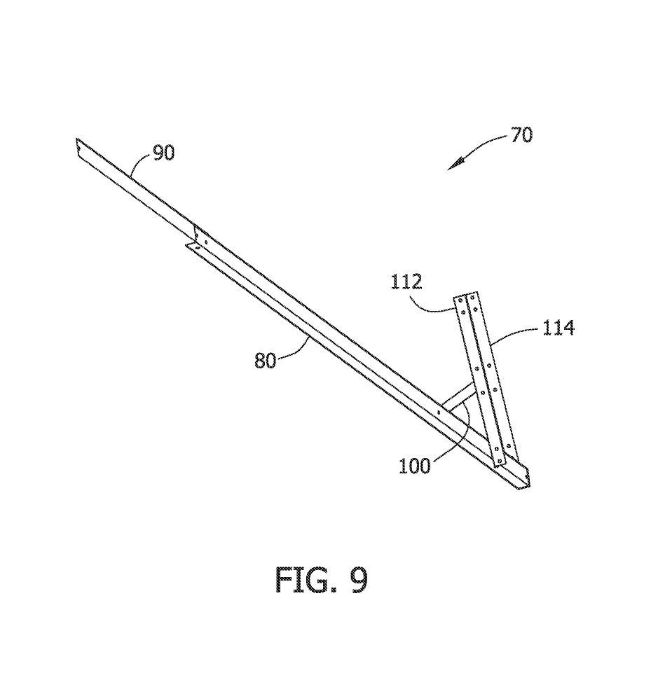

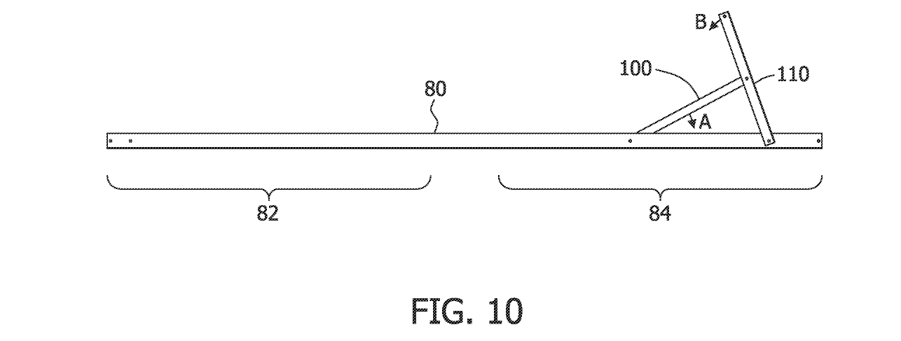

Referring to FIGS. 7-10, support rack 16 includes a pair of trusses 70, a crossbeam 120, a frame assembly 130, and a rib 170. Trusses 70 and frame assembly 130 may be preassembled at either a factory or another location prior to installation. Each of the pair of trusses 70 is substantially identical. In this embodiment, each truss 70 includes the same parts and is interchangeable with other trusses. However, the pair of trusses 70 may have different configurations, including two separate trusses with similar, yet oppositely positioned parts.

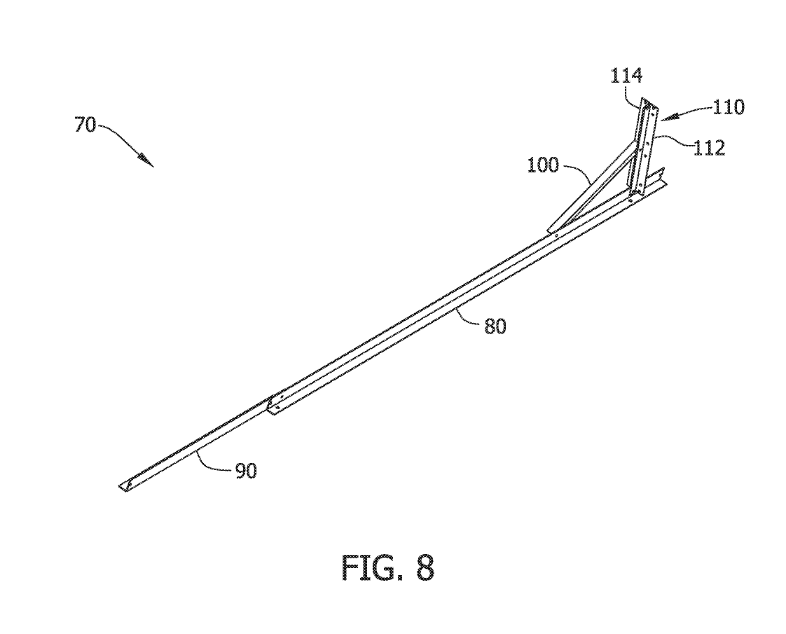

As shown in FIGS. 8-10, each of the pair of trusses 70 includes a runner 80, a spacer 90, a brace 100, and a support 110. Runner 80 defines a forward portion 82, a rearward portion 84, and a longitudinal length therebetween. Spacer 90 is attached to and extends longitudinally forward from forward portion 82 of runner 80.

Brace 100 is attached to runner 80 along the rearward portion 84 and extends vertically upward at a rearward angle. Support 110 is attached to runner 80 at a location rearward of brace 100 and extends vertically upward at a forward angle. Support 110 and brace 100 are connected, such that support 110 extends vertically above brace 100.

Support 110 includes a first strut 112 and a second strut 114. In this embodiment, first strut 112 and second strut 114 are substantially identical and may be used interchangeably. However, the struts may have different configurations. For example, the struts need not be interchangeable.

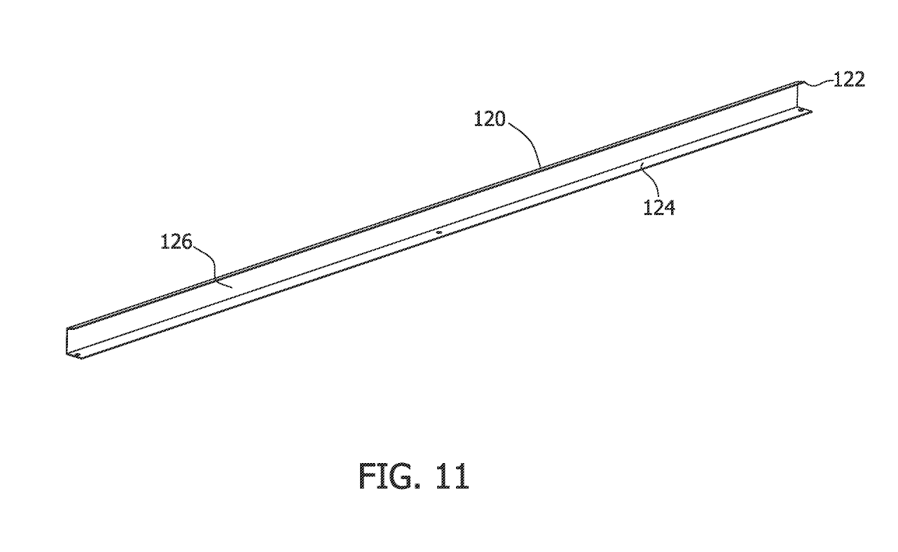

Crossbeam 120 connects the forward portion 82 of one runner 80 to the forward portion 82 of another runner 80. As shown in FIG. 11, crossbeam 120 is a channel having a “C” shape open to the aft of the rack, and a top leg 122 and a bottom leg 124 of different lengths. However, the legs may be of equal lengths. Top leg 122 and bottom leg 124 are connected by a web 126. Web 126 has a height that is substantially similar to the height of frame 32 of solar module 12 to allow placement thereof between top leg 122 and bottom leg 124. Top leg 122 extends outward from web 126 at an angle, such that top leg 122 and bottom leg 124 are not parallel.

In this embodiment, crossbeam 120 is suitably made of bent aluminum sheet metal. However, other material and means of construction may be used to manufacture the crossbeam. Among the various materials and manufacturing processes that may be used are plastic, other metals, extruded bars, and molded bars. Other configurations of the crossbeam are also contemplated, including shapes that allow solar module 12 to be attached to an upper surface of the crossbeam.

Frame assembly 130 is attached to each pf the pair of trusses through the respective support 110. Frame assembly 130 includes a mounting bar 140, a footer 150, and a plurality of stringers 160.

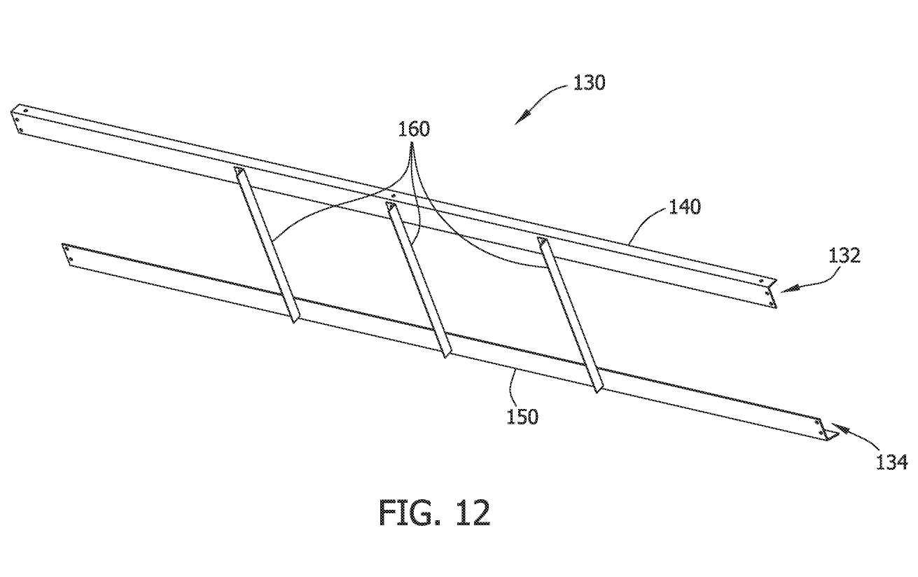

As best shown in FIG. 12, mounting bar 140 extends across a top 132 of frame assembly 130. Footer 150 extends across a bottom 134 of frame assembly 130 to support a bottom edge of the ballast 14. The plurality of stringers 160 extend vertically between mounting bar 140 and footer 150. Each of the plurality of stringers 160 are attached to mounting bar 140 and footer 150 and are in spaced relation with another of the plurality of stringers 160.

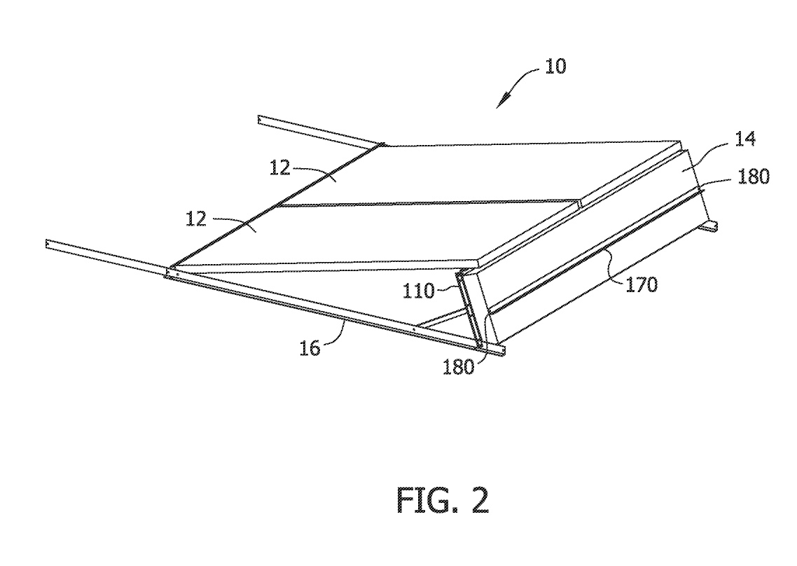

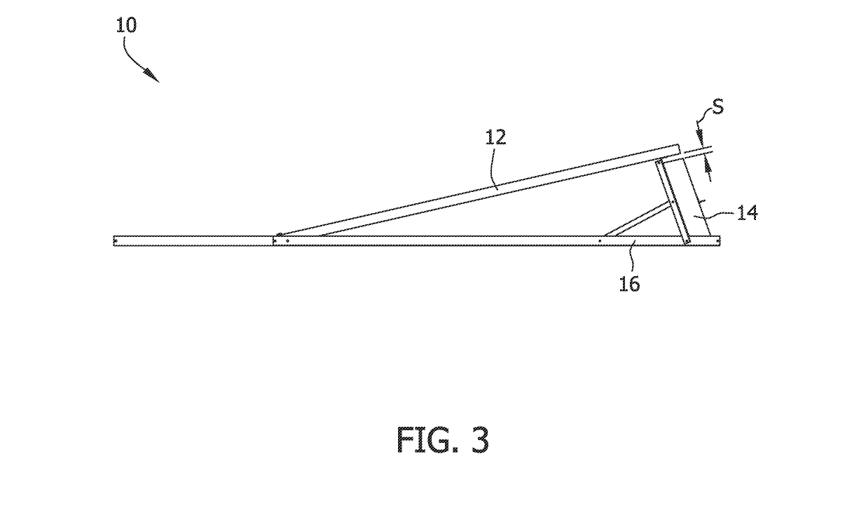

As shown in FIG. 2, ballast 14 is attached through rib 170 to supports 110. Ballast 14 rests against and is supported by frame assembly 130 in spaced relation to solar module 12 to allow air flow for reducing the temperature of the solar module 12 and increasing power output. The space “S” (best shown in FIG. 3) between the ballast and module is suitably between approximately 20 mm and approximately 40 mm. In this embodiment, the space “S” between ballast 14 and solar module 12 is approximately 28 mm (1.10 inches).

Rib 170 is located rearward of ballast 14 and extends approximately across the length of the ballast. The rib 170 is suitably connected to supports 110 by fasteners 180 extending through ballast 14. Thus, a positive locking system is provided across the length of the ballast 14 for securing the ballast to support rack 16. The rib 170 and the fasteners 180 are externally visible, and thereby provide a visible quality check because their absence is easily seen.

As discussed above, the forward edge 44 of solar module 12 is sized to fit into the center of crossbeam 120. Top leg 122 and bottom leg 124 act to vertically retain forward edge 44 within the center of crossbeam 120. Web 126 acts to limit forward longitudinal movement of forward edge 44. Alternatively, a positive fastening means may be used to retain solar module 12 within crossbeam 120.

The rearward edge 46 of solar module 12 is attached to mounting bar 140 of frame assembly 130 to inhibit vertical and horizontal movement of rearward edge 46 with respect to mounting bar 140 and to inhibit rearward longitudinal movement of solar module 12 by providing a rear stop. As shown in FIG. 2, solar module 12 is in spaced relation to each truss 70 such that the solar module is substantially unsupported along each side edge 48.

By inhibiting vertical, horizontal, and longitudinal movement of the solar panel 12, the support rack 16 provides a load path to transfer loads from solar module 12 into frame assembly 130. Thus, the solar module 12 forms a portion of the structure (i.e., the module is a structural member) of fixed tilt racking system 10. As a structural member, solar module 12 is capable of transferring wind loads and other loads along frame 32 and into support rack 16.

The angle between runner 80 and solar module 12 is suitably between approximately 8° and approximately 15°, though other angles may be used. In this embodiment, the angle between runner 80 and solar module 12 is approximately 13°.

Components of the fixed tilt racking system 10 are suitably either extrusions that have been cut to length or bent or rolled sheet metal. Advantageously, the extruded or bent metal components are easy to manufacture and minimize the cost of the system. The extrusions are cut to length and placed into fixtures for pre-drilling. The sheet metal may be pre-drilled before forming As a result, the parts can be sub-assembled, transported to the site of installation, and then assembled and installed relatively quickly and inexpensively.

For example, runner 80, spacer 90, brace 100, and support 110 may be preassembled to form truss 70. The truss 70 is suitably formed by aligning the holes of the pre-drilled parts and attaching them to one another. In another embodiment, the spacer 90, brace 100, and support 110 are attached to the runner 80 and folded to reduce the overall space needed to transport the truss 70.

Frame assembly 130 is also preassembled by aligning mounting bar 140, footer 150, and the plurality of stringers 160 and attaching them together. The preassembled trusses 70 and frame assemblies 130, crossbeam 120, and rib 170 are then bundled together into a kit and transported to the installation sight. Solar modules 12 and ballast 14 may be transported to the installation site either separately from or together with the bundled parts.

Once at the installation site, the trusses 70 may be unfolded and the brace 100 and support 110 attached to each other to form the side of the support rack 16. Then the trusses 70, frame assembly 130, and crossbeam 120 are assembled together before being attached to the structure. After attachment of the assembly is attached to the structure, solar modules 12, ballast 14, and rib 170 are attached to the assembly.

The embodiments of the fixed tilt racking system and method for installation described herein provide a rack system with a lower associated cost to manufacture and to install when compared to prior systems and methods. For example, most of the parts described are simple extrusions of low complexity. The extrusions are pre-cut to specified lengths. The sheet metal parts include simple bends that are relatively easy to manufacture. Both the extrusions and the sheet metal parts are pre-drilled at specific locations to ease assembly. The subassemblies are then quickly and easily manufactured by aligning the pre-drilled holes and attaching the parts together using conventional methods. Further, the present embodiment allows the majority of parts to be made and preassembled in mass quantity.

The subassemblies and parts are bundled together and transported to the installation site. The bundled subassemblies and parts reduce the area needed to transport and store the support rack, while reducing the parts required to be tracked and assembled at the installation site. Additionally, the fixed tilt racking system can quickly be assembled at the installation site using a reduced number of fasteners.

When introducing elements of the present disclosure or the embodiments thereof, the articles “a”, “an”, “the” and “said” are intended to mean that there are one or more of the elements. The terms “comprising”, “including” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above without departing from the scope of the present disclosure, it is intended that all matter contained in the above description and shown in the accompanying drawings shall be interpreted as illustrative and not in a limiting sense.

What is claimed is:

1. A fixed tilt racking system for mounting solar modules to a structure, the fixed tilt racking system comprising:
a support rack;
a ballast mounted to the support rack; and
a solar module attached to and supported by the support rack along a forward edge and a rearward edge of the solar module; the solar module being substantially unsupported along each side edge.

2. The fixed tilt racking system of claim 1, wherein the support rack includes a first truss and a second truss in spaced relation to the solar module.

3. The fixed tilt racking system of claim 2, wherein each of the first truss and the second truss includes:
a runner defining a forward portion, a rearward portion, and a longitudinal length;
a brace being connected with and extending vertically from the runner along the rearward portion; and
a support being connected with and extending vertically from the runner at a location rearward from the brace, the support being connected with the brace.

4. The fixed tilt racking system of claim 3, wherein each of the first truss and the second truss includes a spacer extending longitudinally forward from the forward portion of the runner to space the fixed tilt racking system with respect to another fixed tilt racking system at a predetermined distance.

5. The fixed tilt racking system of claim 2, wherein each of the first truss and the second truss are interchangeable.

6. The fixed tilt racking system of claim 2, further comprising a crossbeam connected with and extending horizontally from the forward portion of the runner of the first truss to the forward portion of the runner of the second truss, the solar module being supported by the crossbeam along a forward edge of the solar module to limit vertical and forward longitudinal movement of the forward edge.

7. The fixed tilt racking system of claim 2, further comprising a frame assembly connected with and extending horizontally from the support of the first truss to the support of the second truss, the frame assembly supporting the solar module in spaced relation to the ballast to allow air flow for reducing the temperature of the solar module.

8. The fixed tilt racking system of claim 7, wherein the frame assembly includes:
a mounting bar extending across a top of the frame assembly, the solar module being supported by the mounting bar along a rearward edge of the solar module;
a footer extending across a bottom of the frame assembly to support a bottom edge of the ballast; and
a plurality of stringers extending vertically from the mounting bar to the footer, each of the plurality of stringers being in a spaced relation with another of the plurality of stringers.

9. A kit for forming a support rack to mount solar modules to a structure, the fixed tilt racking kit comprising:
a first truss and a second truss, each of the first truss and the second truss includes:
a runner defining a forward portion, a rearward portion, and a longitudinal length;
a brace for connecting with the runner along the rearward portion of the runner;
a support for connecting with the runner at a location rearward from the brace, each of the runner and brace and support being pre-drilled to ease assembly.

10. The kit of claim 9, wherein the brace is connected with the runner along the rearward portion of the runner; the support is connected with the runner at a location rearward from the brace, the support is connected with the brace.

11. The kit of claim 9, further comprising a crossbeam for connecting the first truss with the second truss along the forward portion of each runner.

12. The kit of claim 9, further comprising a frame assembly for connecting with and extending horizontally from the support of the first truss to the support of the second truss.

13. The kit of claim 9, further comprising a ballast for connecting with the frame assembly and each support.

14. The kit of claim 9, further comprising a solar module for connecting with the crossbeam and to provide a downward force to the support rack.

15. A method of installing a solar module to a structure with a support rack, the method comprising:
attaching the support rack to the structure;
inserting a forward edge of the solar module into a channel extending along the forward portion of the support rack to limit vertical and forward longitudinal movement of the forward edge; and
attaching a rearward edge of the solar module to the support rack to inhibit vertical and horizontal movement of the rearward edge.

16. The method of claim 15, further comprising assembling the support rack by attaching a crossbeam and frame assembly to a first truss and a second truss.

17. The method of claim 16, wherein each truss includes:
a runner defining a forward portion, a rearward portion, and a longitudinal length;
a brace being connected with the runner along the rearward portion of the runner;
a support being connected with the runner at a location rearward from the brace, the support being connected with the brace.

18. The method of claim 17, wherein the step of assembling the support rack includes sub-assembling the brace and the support to the runner.

19. The method of claim 15, further comprising attaching a ballast to the support rack.

20. The method of claim 19, wherein the ballast is connected to the support rack in spaced relation to the solar module.
